(19) United States
(12) Patent Application Publication
(10) Pub. No.: US 2004/0200591 A1
(43) Pub. Date: Oct. 14, 2004

(54) Material based on organic and/or inorganic fibres having germicidal properties and uses thereof

(76) Inventor: Joseph Dussaud, Charlemagne Vienne (FR)

Correspondence Address: NIXON & VANDERHYE, PC, 1100 N GLEBE ROAD, 8TH FLOOR, ARLINGTON, VA, 22201-4714, US

(21) Appl. No.: 10/485,088

(22) PCT Filed: Jun. 20, 2002
(86) PCT No.: PCT/FR02/02149

(30) Foreign Application Priority Data
Jul. 31, 2001 (FR) 01/10227

(51) Int. Cl. A01G 7/00; D21H 11/00; A62B 18/08; A62B 23/02; B01D 46/06; B01D 46/08; A62B 7/10; B01D 46/02

(52) U.S. Cl. 162/161; 47/9; 128/206.12; 55/361

(57) ABSTRACT

The invention concerns a permeable material containing a fibrous composition consisting of organic and/or inorganic fibres characterised in that it further contains between 0.1 and 10 g/m², advantageously 1 g/m² of activated carbon fibres whereon is adsorbed a germicidal agent.

The invention concerns a new material based on organic and/or inorganic fibres having germicidal properties. It also relates to different uses of the said material for designing articles for which bactericide properties are required.

There are a great number of fields, in which the contamination by the bacteria in the surrounding environment (water or air) is tried to be avoided. Thus, e.g. in the air conditioning field, the so-called HEPA (High Efficiency Particle Arrestor) high efficiency filtration systems are commonly used to avoid the possible bacterial contaminations. The filtering media used for these applications allow mechanical stopping of the micro organisms (bacteria, virus, spores etc.), but they cannot avoid the reproduction thereof upstream or downstream of the medium and finally the spreading thereof into the ventilation channels. The treatment of water or air can also be carried out by photocatalysis, the filtering medium thus consisting of a support coated with a photocatalytic composition containing a photocatalytic agent e.g. of the TiO2 type. These media do not have any bactericidal properties in the absence of UV radiation.

The problem is the same concerning the anti-pollution masks used in a certain number of professions in a continuous contact with contaminated environment (white rooms in particular) or used e.g. by the asthmatic. The masks are capable of stopping mechanically the bacteria, but they cannot, however, avoid the proliferation thereof to the surfaces of the masks so that the user eventually inhales considerable amounts of germs.

The mulching papers used in the agricultural field are, most of the time, treated with fungicidal or anti-mildew agents of the metallic salts type. This is the case e.g. with the document FR-A-2 016 071, which describes a mulching paper containing a precipitate of a hydroxyquinoline solution and a mineral salt solution. In practice, the precipitate is added directly to the pulp during the paper manufacturing process. Even if such a paper has interesting germicidal properties, one would expect, considering the considerable amount of metals in the paper, a massif spreading of the said metals into the soil and therefore a considerable pollution of the environment.

We are confronted with the same kind of problem in the field of food packaging, in which environment the bacteria is able to develop rapidly. The idea of a bactericide packaging thus gains ground and this would allow obtaining a longer conservation of the foodstuff. However, the presence of metallic salts in this kind of paper is forbidden if there is any risk of spreading metals capable, in turn, of contaminating the foodstuff by contact.

In other words, the problem that the invention proposes to solve is how to develop a material able to be used among other things in the aforementioned applications, which have a germicidal activity having, however, any risk of pollution with regard to the immediately surrounding environment, be it air, food or even water.

Such a material can further find other applications, especially such as wall paper, acoustic panel, vacuum-cleaner dust bag or wiping paper. In fact, it would be interesting if such articles would have bactericide properties allowing decontaminating the air of a chamber, especially that of a nursery (in case of wall papers and acoustic panels), destroying bacteria and thus avoiding the proliferation of the bacteria out of the vacuum-cleaner (in case of dust bags), or avoiding any risk of contamination with the skin (in case of wiping papers), especially for cleaning the skin of the babies.

To do this, the invention proposes a permeable material containing a fibrous composition consisting of organic and/or inorganic fibres.

The material is characterized in that it further contains activated carbon fibres whereon is adsorbed a germicidal agent.

The Applicant has in fact had the idea of attaching the germicidal agent directly on the activated carbon fibres, which are known to have a high specific surface area, which allows not only reducing considerably the amount of the germicidal agent required for obtaining a sufficient bactericide efficiency, but also incorporating the activated carbon fibres in very small amounts into the material, thus reducing the production cost.

For obtaining satisfactory bactericide efficiency, the material contains between 0.1 and 10 g/m², advantageously 1 g/m² of activated carbon fibres. For a mass less then 0.1 g/m², a satisfactory bactericide efficiency is not obtained. For a mass higher then 10 g/m², the bactericide efficiency is total.

In the rest of the description and in the claims, the expression “permeable material” denotes a structure permeable to air and to liquid effluents, the material being obtained from fibres for textile use, organic and inorganic, by themselves or as a mixture, the material being able to be a non-woven, a fabric or even a grid.

The activated carbon fibres as such are perfectly known and the manufacturing process thereof is described more precisely in the document Fr 97.14704, which is hereby incorporated by reference.

The main thing is that the first possibility consists of a carbon fibre texture, which is subjected to an activation treatment. The carbon fibre texture is obtained directly from carbon yarns or fibres stemming from a carbon precursor by heat treatment or from carbon precursor yarns or fibres, in which case the precursor transformation heat treatment is carried out after shaping of the texture.

The carbon precursor used is cellulose, more precisely rayon, and the final phase of the precursor carbonisation heat treatment is carried out at a temperature of between 1000° C. and 1300° C., under a nitrogen atmosphere and it takes 0.7-1.3 minutes.

The activation is carried out by heat treatment of the carbon fibre texture under oxidizing atmosphere, such as water vapour or, preferably, carbon dioxide or a mixture of carbon dioxide and water vapour. The heat treatment temperature is preferably between 850° C. and 950° C. and it lasts preferably for 50-300 minutes depending on the desired specific surface area.

The second possibility consists of a carbon precursor fibre texture, which is impregnated with a composition allowing, after carbonisation, obtaining directly a carbon fibre activated texture.

The carbon precursor is preferably cellulose and more precisely rayon. The impregnation is carried out with a composition containing a constituent chosen among the phosphoric acid, the zinc chloride, the potassium sulphate, the potassium hydroxide, the diamonic phosphate and the ammonium chloride. Preferably, the impregnation is carried out by one composition containing phosphoric acid so that the acid mass attached on the texture is between 4 and 13% of the dry texture mass. The heat treatment is preferably carried out at a temperature of between 350° C. and 500° C. under inert atmosphere or under an atmosphere containing a reaction activator such as carbon dioxide or water vapour.

According to the invention, the germicidal agent is adsorbed on the activated carbon fibres.

In practice, the germicidal agent is a metallic salt chosen from the group comprising the silver, copper, zinc and platinum salts. The expression “salt” denotes here in a non limitative manner the chlorides, sulphates, nitrates etc.

In practice, the metallic salt coating can be carried out by cation exchange, by liquid impregnation or under vacuum.

As already said, one of the essential advantages of the invention consists in proposing a material having a very small amount of germicidal agent, in this case metallic salt, and for which any risk of spreading metal to the direct environment is eliminated. In practice, the metallic salt, advantageously the silver salt represents between 0.01 and 1%, advantageously 0.05% by weight of the activated carbon fibres.

It is clear that the structure of the material incorporating the activated carbon fibres treated with the germicidal agent depends on the further use thereof. As already mentioned, the materials involved are a non-woven, a fabric or even a grid.

As organic fibres entering to the composition of the material of the invention are used, preferably but not in a limitative manner, the natural fibres, especially cellulose fibres, cotton fibres, the organic chemical fibres, especially modified cellulose, methylcellulose, rayon, acrylic, nylon, polyester, polyethylene, polypropylene, polyamide fibres. The inorganic fibres that can be used in the material of the invention are particularly the glass or metal fibres.

In an advantageous embodiment, the permeable material contains, besides the activated carbon fibres, exclusively cellulose fibres.

Moreover and according to another characteristic, the mechanical resistance and the mass of the material can vary depending on the viewed application. In practice, the mass of the material is between 10 and 1000 g/m².

As already stated, the material can be used in multiple applications and especially, but not in a limitative manner, as a mulching paper, photocatalytic, or not, filtering medium, (to be used e.g. as a medium in the air conditioning systems, anti-pollution masks and vacuum-cleaner dust bags), wall paper, acoustic panel, wiping paper or food package.

In a particular embodiment, the invention concerns a mulching paper, the mass of which is between 60 and 120 g/m², comprising:

a fibrous composition containing:

from 40 to 60% of coniferous kraft paper pulp,

from 10 to 30% of deciduous kraft paper pulp,

from 20 to 40% of deinked packaging pulp.

from 0.1 to 10 g/m² of activated carbon fibres whereon is adsorbed from 0.01 to 0.1% of silver salt by weight of the activated carbon fibres.

According to another embodiment, the invention concerns a wall paper, the mass of which is between 80 and 250 g/m², comprising:

a fibrous composition containing:

from 10 to 30% by weight of the coniferous kraft paper pulp,

from 70 to 90% by weight of the deciduous kraft paper pulp,

from 5 to 15% of mineral fillers by weight of the dry fibrous composition,

from 0.1 to 10 g/m² of activated carbon fibres whereon is adsorbed from 0.01 to 0.1% of silver salts by weight of the activated carbon fibres.

According to another embodiment, the invention concerns a vacuum-cleaner dust bag, the mass of which is between 20 and 150 g/m² comprising:

a fibrous composition containing:

from 50 to 70% by weight of the coniferous pulp,

from 30 to 50% by weight of the deciduous pulp,

from 5 to 15% by weight of the dry fibrous composition of acrylic latex

from 0.1 to 10 g/m² of activated carbon fibres whereon is adsorbed from 0.01 to 0.1% of silver salt by weight of the activated carbon fibres.

An object of the invention is also a wiping paper, the mass of which is between 10 and 300 g/m², comprising:

a fibrous composition containing:

from 10 to 30% by weight of rayon,

from 70 to 90% of coniferous kraft paper pulp,

from 0.1 to 10 g/m² of activated carbon fibres whereon is adsorbed from 0.01 to 0.1% of silver salt by weight of the activated carbon fibres.

The invention relates also to an anti-pollution mask, the mass of which is between 30 and 150 g/m², comprising:

a fibrous composition containing:

from 10 to 30% by weight of rayon,

from 70 to 90% by weight of polyester fibres,

from 10 to 30% of acrylic latex by weight of the dry fibrous composition,

from 0.1 to 10 g/m² of activated carbon fibres whereon is adsorbed from 0.01 to 0.1% of silver salt by weight of the activated carbon fibres.

An object of the invention is a food package, the mass of which is between 35 and 150 g/m², comprising:

a fibrous composition containing:

from 20 to 100% of coniferous kraft,

from 0 to 80% of deciduous kraft,

from 0.1 to 10 g/m² of activated carbon fibres whereon is adsorbed from 0.01 to 0.1 of silver salt by weight of the activated carbon fibres.

The invention and the advantages which stem therefrom will become more apparent from the following illustrative examples.

### EXAMPLE 1

### a/ Manufacture of the Material of the Invention

A material, the mass of which is 100 g/m², was manufactured with the following composition:

fibrous composition: 30% of semi-bleached coniferous kraft paper pulp, and 70% of deciduous kraft paper pulp,

1% of activated carbon fibres by weight of the dry fibrous composition, which is 1 g/m², whereon is adsorbed 0.05% of silver nitrate by weight of the activated carbon fibres, which is 0.5 mg/m².

i/ Preparation of Activated Carbon Fibres

A rayon fabric consisting of multifilament viscose obtained from yarns of 190 dTex woven on a construction of 15×15 (15 yarns per cm as warp and weft yarns).

After desizing, the fabric is carbonized by being heated up to a final temperature of about 1200° C. during about 1 minute under the influence of nitrogen. The activation of the carbon fabric obtained is carried out by advancing the fabric into a heat treatment zone of an oven under an atmosphere consisting of 100% of carbon dioxide. This zone, as well as the zones in which the temperature rises and falls, is materialized by a tunnel-shaped mould, along which the fabric advances continuously. The heat treatment is carried out at a temperature of about 920° C. and the dwell time at this temperature is about 1 h.

The activated carbon fabric obtained has an average size microporosity of about 0.6 nm.

ii/ Treatment of the Fibres with the Silver Nitrates

A sample of 100 g of active carbon fabric is impregnated with an aqueous solution of silver nitrate having a silver ion concentration of 50 mg/l or 79 mg/l of silver nitrate (0, 00046 mol/l). After drying at 150° C., the obtained fibres contain 0.05% of silver.

iii/ Manufacture of the Material

1% by weight of the activated fibres treated with the silver salt is introduced directly into the pulper containing the fibrous composition at a concentration of 40 g/l. The homogenization lasts 20 min and then the sheet, the mass of which is 100 g/m², is manufactured on a paper machine so that its characteristics correspond to those of wall paper.

### b) Bactericide Effect of the Material of the Invention

The above-manufactured material is contaminated with a suspension of 10⁶ UFC/ml of Escherichia Coli and Bacillus subtilis bacteria. The decontamination rate is observed at regular intervals during 128 minutes. The results are given in the table below:

| | | MESURES ON BACILLUS |
|---|---|---|
| | MESURES ON E COLI | SUBTILIS |
| TIME (Minutes) | Concentration (UFC/ml) | Concentration (UFC/ml) |
| 0 | 3000000 | 3000000 |
| 4 | 40000 | 400000 |
| 8 | 200 | 200000 |
| 16 | 1 | 1500 |
| 32 | 0 | 200 |
| 64 | 0 | 10 |
| 128 | 0 | 3 |

As can been seen from the table, a diminution of 3-6 logs is observed in 15 minutes.

### EXAMPLE 2

A mulching paper having the following composition was prepared:

fibrous composition:

50% of coniferous unbleached kraft paper pulp

20% of deciduous unbleached kraft paper pulp,

30% of deinked packaging pulp,

5.2 of carbon black colorant (by weight of the dry fibrous composition).

0.1% of activated carbon fibres (by weight of the activated carbon fibres).

The obtained mass of the paper was 85 g/m².

### EXAMPLE 3

A wall paper having the following composition was prepared:

fibrous composition:

20% by weight of the coniferous semi-bleached kraft paper pulp,

80% by weight of the deciduous semi-bleached kraft paper pulp,

10% of mineral fillers (Talc) (by weight of the dry fibrous composition).

1% of aluminium sulphate (by weight of the dry fibrous composition)

1% of modified colophony (by weight of the dry fibrous composition)

0.1% of activated carbon fibres (by weight of the dry fibrous composition) containing 0.05% of silver salt (by weight of the activated carbon fibres).

The obtained mass of the paper was 120 g/m².

### EXAMPLE 4

A vacuum-cleaner's dust bag paper having the following composition was prepared:

fibrous composition:

60% by weight of coniferous pulp,

40% by weight of deciduous pulp,

10% of acrylic latex (by weight of the dry fibrous composition)

1% of aluminium sulphate (by weight of the dry fibrous composition)

1% of modified colophony (by weight of the dry fibrous composition)

0.1% of activated carbon fibres (by weight of the dry fibrous composition) containing 0.05% of silver salt (by weight of the activated carbon fibres).

The obtained mass of the paper was 50 g/m².

### EXAMPLE 5

A wiping paper having the following composition was prepared:

fibrous composition:

20% by weight of rayon (1.7 dTex, 8 mm),

80% by weight of coniferous bleached kraft paper pulp,

0.1 of activated carbon fibres (by weight of the dry fibrous composition) containing 0.05% of silver salt (by weight of the activated carbon fibres).

The obtained mass of the paper was 40 g/m².

### EXAMPLE 6

An anti-pollution mask comprising the following composition was prepared:

fibrous composition:

20% by weight of rayon,

80% by weight of polyester fibres,

20% of acrylic latex (by weight of the dry fibrous composition)

0.1% of activated carbon fibres (by weight of the dry fibrous composition) containing 0.05% of silver salt (by weight of the activated carbon fibres).

The obtained mass of the paper was 45 g/m².

### EXAMPLE 7

A food package having the following composition was prepared:

fibrous composition:

100% of coniferous kraft,

3% of oxydized starch,

0.5% of cationic starch

0.1% of activated carbon fibres (by weight of the dry fibrous composition) containing 0.05% of silver salt (by weight of the activated carbon fibres).

The obtained mass of the paper was 60 g/m².

1. Permeable material containing a fibrous composition consisting of organic and/or inorganic fibres characterized in that it further contains between 0.1 and 10 g/m², advantageously 1 g/m², of activated carbon fibres whereon is adsorbed a germicidal agent.

2. Material according to claim 1, characterized in that the germicidal agent is a metallic salt chosen from the group comprising the silver, copper, zinc and platinum salts.

3. Material according to claim 2, characterized in that the metallic salt represents between 0.01 and 1%, advantageously 0.05%, by weight of the activated carbon fibres.

4. Material according to claim 1, characterized in that the organic fibres are chosen from the group comprising the cellulose, cotton, modified cellulose, methylcellulose, rayon, acrylic, nylon, polyester, polyethylene, polypropylene, polyamide fibres.

5. Material according to claim 1, characterized in that has a mass of between 10 and 1000 g/m².

6. Material according to claim 1, characterized in that the inorganic fibres are chosen from the group comprising the glass fibres and metal fibres.

7. Use of the material, object claim 1, as mulching paper, wall paper, acoustic panel, wiping paper, filtering medium (photocatalytic or not), food package.

8. Mulching paper, the mass of which is between 60 and 120 g/m², comprising:
a fibrous composition containing:
from 40 to 60% of coniferous kraft paper pulp,
from 10 to 30% of deciduous kraft paper pulp,
from 20 to 40% of deinked packaging pulp.
from 0.1 to 10 g/m² of activated carbon fibres whereon is adsorbed from 0.01 to 0.1% of silver salt by weight of the activated carbon fibres.

9. Wall paper, the mass of which is between 80 and 250 g/m², comprising:
a fibrous composition containing:
from 10 to 30% by weight of the coniferous kraft paper pulp,
from 70 to 90% by weight of the deciduous kraft paper pulp,
from 5 to 15% of mineral fillers by weight of the dry fibrous composition,
from 0.1 to 10 g/m² of activated carbon fibres whereon is adsorbed from 0.01 to 0.1% of silver salts by weight of the activated carbon fibres.

10. Vacuum-cleaner dust bag paper, the mass of which is between 20 and 150 g/m², comprising:
a fibrous composition containing:
from 50 to 70% by weight of the coniferous pulp,
from 30 to 50% by weight of the deciduous pulp,
from 5 to 15% by weight of the dry fibrous composition of acrylic latex
from 0.1 to 10 g/m² of activated carbon fibres whereon is adsorbed from 0.01 to 0.1% of silver salt by weight of the activated carbon fibres.

11. Wiping paper, the mass of which is between 10 and 300 g/m², comprising:
a fibrous composition containing:
from 10 to 30% by weight of rayon,
from 70 to 90% of coniferous kraft paper pulp,
from 0.1 to 10 g/m² of activated carbon fibres whereon is adsorbed from 0.01 to 0.1% of silver salt by weight of the activated carbon fibres.

12. Anti-pollution mask, the mass of which is between 30 and 150 g/m², comprising:
a fibrous composition containing:
from 10 to 30% by weight of rayon,
from 70 to 90% by weight of polyester fibres,
from 10 to 30% of acrylic latex by weight of the dry fibrous composition,
from 0.1 to 10 g/m² of activated carbon fibres whereon is adsorbed from 0.01 to 0.1% of silver salt by weight of the activated carbon fibres.

13. Food package, the mass of which is between 35 and 150 g/m², comprising:
a fibrous composition containing:
from 20 to 100% of coniferous kraft,
from 0 to 80% of deciduous kraft,
from 0.1 to 10 g/m² of activated carbon fibres whereon is adsorbed from 0.01 to 0.1 of silver salt by weight of the activated carbon fibres.

14. Use of the material, object of claim 2, as mulching paper, wall paper, acoustic panel, wiping paper, filtering medium (photocatalytic or not), food package.

15. Use of the material, object of claim 3, as mulching paper, wall paper, acoustic panel, wiping paper, filtering medium (photocatalytic or not), food package.

16. Use of the material, object of claim 4, as mulching paper, wall paper, acoustic panel, wiping paper, filtering medium (photocatalytic or not), food package.

17. Use of the material, object of claim 5, as mulching paper, wall paper, acoustic panel, wiping paper, filtering medium (photocatalytic or not), food package.

18. Use of the material, object of claim 6, as mulching paper, wall paper, acoustic panel, wiping paper, filtering medium (photocatalytic or not), food package.
